(19) United States
(12) Patent Application Publication
(10) Pub. No.: US 2017/0038123 A1
(43) Pub. Date: Feb. 9, 2017

(54) CRYOGENIC FLUID CIRCUIT DESIGN FOR EFFECTIVE COOLING OF AN ELONGATED THERMALLY CONDUCTIVE STRUCTURE EXTENDING FROM A COMPONENT TO BE COOLED TO A CRYOGENIC TEMPERATURE

(71) Applicant: VICTORIA LINK LTD, Wellington (NZ)

(72) Inventors: Nicholas Strickland, Lower Hutt (NZ); Stuart Wimbush, Lower Hutt (NZ)

(21) Appl. No.: 15/304,154

(22) PCT Filed: Apr. 16, 2015
(86) PCT No.: PCT/IB2015/052798

§ 371 Date: Oct. 14, 2016

Related U.S. Application Data
(60) Provisional application No. 61/980,896, filed on Apr. 17, 2014.

(51) Int. Cl. F25D 19/00; H01F 6/04; F25D 29/00; F25B 9/00; F25B 9/10

(52) U.S. Cl. CPC F25D 19/00; F25B 9/00; F25B 9/10; F25D 29/001; H01F 6/04

(57) ABSTRACT

A cryogenic system includes a housing of a cryogenic chamber, a cold source in the cryogenic chamber, and a circulation loop for circulating cryogenic fluid between the cold source and a component to be cooled in the cryogenic chamber. The component has an elongated thermally conductive structure extending to a warmer environment. For adjustable cooling of the structure, an incoming stream of the cryogenic fluid is directed along a length of the structure extending from the component, and this stream is split into a first outgoing stream at a first location from the component and a second outgoing stream at a second location further from the component, and an adjustable valve adjusts the fraction of the incoming stream that becomes the second outgoing stream.

### TECHNICAL FIELD

This disclosure relates to circulation of cryogenic fluid in a cryogenic system, and a fluid circuit design for effective cooling of an elongated thermally conductive structure that extends from a component that is being cooled to a warmer environment. Such structures may include but are not limited to current leads, mechanical supports, mechanical feedthroughs, and rotational bearings.

### BACKGROUND ART

The properties of common materials often change when the materials are cooled to a cryogenic temperature, and these changes complicate the design of cryogenic apparatus. These changes become substantial below a temperature of about 150 degrees Kelvin. Therefore, in this disclosure, “cryogenic” relates to a temperature below 150 degrees Kelvin. For example, “cryogenic gas” is a gas of a material that has a boiling point below 150 degrees Kelvin, and “cryogenic fluid” is a gas of a material that has a boiling point below 150 degrees Kelvin or a liquid of a material that has a freezing point below 150 degrees Kelvin. Examples of cryogenic gas include helium, hydrogen, neon, nitrogen, fluorine, argon, oxygen, and krypton. The design of cryogenic apparatus for use below 70 degrees Kelvin is particularly difficult, because just a few elements have boiling points below 70 degrees Kelvin. These elements are hydrogen (boiling at 20.3 degrees Kelvin), helium (boiling at 4.2 degrees Kelvin), and neon (boiling at 27.1 degrees Kelvin).

A cryogenic system often includes a housing of a cryogenic chamber, a cold source, and a circulation loop for circulating cryogenic fluid between the cold source and material to be cooled to a cryogenic temperature in the cryogenic chamber. Typically helium is used as the cryogenic fluid in the circulation loop because helium has the lowest boiling point, enabling attainment of the lowest temperature, helium is inert and not flammable in comparison to hydrogen, and helium is less expensive than neon. For example, a gas circulation loop in a cryogenic apparatus has used a cryogenic fan as a centrifugal pump to circulate helium gas between a cryocooler and the material to be cooled to a cryogenic temperature. A passive, gravity-assisted thermosiphon loop has also been used to circulate helium gas or liquid between a cryocooler and material to be cooled to a cryogenic temperature.

A cryogenic system often includes a component to be cooled to a cryogenic temperature, and an elongated thermally conductive structure extending from the component in the cryogenic chamber to a warmer environment. The elongated thermally conductive structure may be required for supporting the component within the cryogenic chamber, for supplying power to the component, for supplying fluid or vacuum to the component, or for adjusting, controlling, or monitoring the component.

For example, the component to be cooled to a cryogenic temperature is an electrical or electronic component, and the elongated thermally conductive structure includes electrical leads for supplying electrical current to the component or conveying electrical signals between the component and the external environment. In one specific example, the component is a sample of material under analysis while electrical properties of the material are measured as a function of temperature. In another example, the component is a superconducting component of an apparatus that exploits the superconducting state when the component is cooled to a cryogenic temperature. For example, the superconducting component is an electromagnet or a superconducting quantum interference device (SQUID) or a superconducting filter element or a superconducting electronic processing device (e.g. analogue/digital converter) or a rapid single flux quantum (RSFQ) computing element. An electronic component can also be cooled to a cryogenic temperature because the performance of the component is improved at lower temperature. For example, the thermal noise of conventional electronic amplifiers and detectors is reduced at lower temperature, while the track resistance and therefore heat dissipation of conventional central processing units (CPUs) is decreased allowing higher clock speeds.

A common problem in cryogenic system design is the cooling of current leads intended to transport an electrical current from outside the system (at room temperature) to an electrical or electronic component at the core of the system (at a cryogenic temperature). By their nature, these electrical current leads represent a significant heat leak into the core of the system, and must be adequately cooled in order to minimise this leak.

When electrical current flows through the current leads, heat due to ohmic loss may also need to be removed in order to adequately cool the electrical or electronic component. The amount of heat due to ohmic loss is the product of the electrical resistance and the square of the current flowing through the electrical resistance. To reduce ohmic loss, current leads carrying significant amounts of current are often made of high temperature superconducting (HTS) wire. Conventional HTS wire has a transition temperature, below which the wire becomes superconducting, of about 77 degrees Kelvin, and its superconducting current capacity becomes higher the further the temperature of the wire is below this transition temperature. Therefore it is common to use conventional HTS wire for current leads to electrical or electronic components that are cooled to cryogenic temperatures that are well below 77 degrees Kelvin, and it becomes additionally important to cool the current leads themselves in addition to the electrical or electronic components.

### SUMMARY OF THE DISCLOSURE

The disclosed embodiments involve an effective and adjustable method of tailoring the degree of cooling applied to an elongated thermally conductive structure extending from a component in a cryogenic chamber to the external environment in order to reduce the heat load upon a cold source in the cryogenic chamber. By reducing the heat load, it is possible to achieve a lower cryogenic base temperature of the system, or use a cold source having a reduced cooling capacity, or reduce power consumed in maintaining the cold source.

In one embodiment, a cryogenic system includes a housing of a cryogenic chamber for containing a component having an elongated thermally conductive structure extending from the component to a warmer environment, a cold source in the cryogenic chamber, and a circulation loop for circulating cryogenic fluid between the cold source and the component in the cryogenic chamber. The circulation loop includes a flow path conduit for directing an incoming stream of cryogenic fluid along a length of the elongated thermally conductive structure extending from the component. To provide an adjustable amount of cooling, the circulation loop further includes a first outgoing stream conduit branching from the flow path conduit at a first location along the length of the elongated thermally conductive structure for conducting a first outgoing stream of the cryogenic fluid from the flow path conduit, a second outgoing stream conduit extending from the flow path conduit at a second location further along the length of the elongated thermally conductive structure than the first location for conducting a second outgoing stream of the cryogenic fluid from the flow path conduit, and an adjustable valve coupled to at least one of the first outgoing stream conduit and the second outgoing stream conduit for adjusting a fraction of the incoming stream of the cryogenic fluid that becomes the second outgoing stream of cryogenic fluid.

In one specific implementation, the adjustable valve is a three-port valve that has a first port connected to the first outgoing stream conduit to receive the first outgoing stream of the cryogenic fluid, a second port connected to the second outgoing conduit to receive the second outgoing stream of the cryogenic fluid, and a third port to expel a combined stream of the cryogenic fluid. For example, in this specific implementation, the combined stream of cryogenic fluid is an inlet flow to a cryogenic pump in the circulation loop.

In another specific implementation, the adjustable valve is a two-port adjustable valve in the second outgoing stream conduit for adjusting a restriction in the second outgoing stream conduit. For example, in this specific implementation, a gas pump in the circulation loop is outside of the housing, a counter-flow heat exchanger is coupled between the first outgoing stream conduit and the gas pump for directing an out-flow of cryogenic fluid through the counter-flow heat exchanger from the first outgoing stream conduit to an inlet of the gas pump, and the counter-flow heat exchanger is also coupled between the gas pump and the cold source for directing an out-flow of the cryogenic fluid from an outlet of the gas pump to the cold source. The second outgoing stream conduit is coupled to the inlet of the gas pump to direct the second outgoing stream to the inlet of the gas pump.

Regardless of the type of adjustable valve that is used in the circulation loop, the adjustable valve can be adjusted either manually or automatically to achieve a desired amount of cooling of the elongated thermally conductive structure. For example, the cryogenic system includes a temperature sensor at a location along the length of the elongated thermally conductive structure, and the adjustable valve is adjusted either manually or automatically by a temperature controller to keep the temperature sensed by the temperature sensor at a temperature set-point.

In another aspect, the present disclosure describes a method of cooling an elongated thermally conductive structure extending from a component in a cryogenic system. The cryogenic system includes a housing of a cryogenic chamber containing the component from which the elongated thermally conductive structure extends to a warmer environment, a cold source in the cryogenic chamber, and a circulation loop circulating cryogenic fluid between the cold source and the component in the cryogenic chamber. The method includes directing an incoming stream of the cryogenic fluid from the cold source along a length of the elongated thermally conductive structure extending from the component, and splitting the steam of the cryogenic fluid along the length of the elongated thermally conductive structure into a first outgoing stream of the cryogenic fluid branching away from the length of the elongated thermally conductive structure and a second outgoing stream of the cryogenic fluid departing away from the length of the elongated thermally conductive structure. The first outgoing stream of the cryogenic fluid branches away from the length of the elongated thermally conductive structure at a first location along the length of the elongated thermally conductive structure, and the second outgoing stream of the cryogenic fluid departs away from the length of the elongated thermally conductive structure at second location further along the length of the elongated thermally conductive structure than the first location. The method further includes adjusting an adjustable valve to adjust a fraction of the incoming stream of the cryogenic fluid that becomes the second outgoing stream of cryogenic fluid.

### BRIEF DESCRIPTION OF THE DRAWINGS

FIG. 1 is a schematic diagram of a cryogenic system using a cryogenic pump to circulate cryogenic fluid between components in a cryogenic chamber, and an adjustable three-port mixing valve for adjustable cooling of current leads to an electrical or electronic component in the cryogenic chamber;

FIG. 2 is a schematic diagram of an automatic control system for automatic control of the cooling of the current leads to the electrical or electronic component;

FIG. 3 is a schematic diagram of a cryogenic system using a room-temperature gas pump and a counter-flow heat exchanger to circulate cryogenic gas between components in a cryogenic chamber, and two adjustable two-port valves for adjustable cooling of current leads to an electrical or electronic component in the cryogenic chamber;

FIG. 4 is a schematic diagram of a more specific example of a cryogenic system that is similar to the cryogenic system in FIG. 3;

FIG. 5 is a perspective view of a helical counter-flow heat exchanger introduced in FIG. 4;

FIG. 6 is a lateral cross-section of a lower end of the heat exchanger of FIG. 5.

### MODES FOR CARRYING OUT THE INVENTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

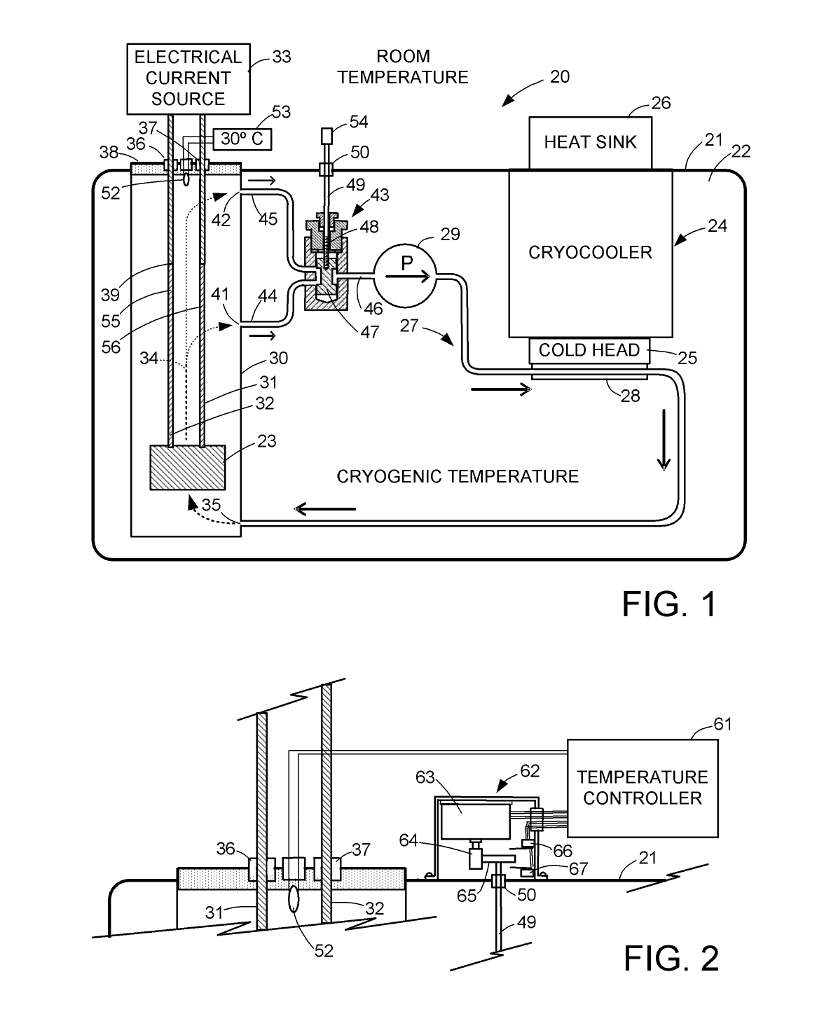

FIG. 1 shows a cryogenic system 20 including a housing 21 for a cryogenic chamber 22. The cryogenic chamber 22 contains a component 23 to be cooled to a cryogenic temperature. The housing 21 provides a way of thermally insulating the component 23 from an external environment that is substantially above any cryogenic temperature. For example, the environment external to the housing 21 is a room-temperature environment, and the region inside the housing 21 is evacuated with a vacuum pump to reduce convective heat transfer from the external environment to the cryogenic chamber 22. The housing 21 may also include layers of heat insulation to reduce radiative heat transfer from the external environment to the cryogenic components in the chamber 22, and components in the cryogenic chamber 22 may be wrapped with heat insulation in order to reduce radiative heat transfer to those components. For example, the heat insulation is super insulation including multiple layers of metalized plastic film.

In order to cool the component 23 to a cryogenic temperature, the cryogenic system 20 includes a cold source 25 in the cryogenic chamber 22. In this example, the cold source 25 is a cold head of a cryocooler 24. The cryocooler 24 pumps heat from the cold head 25 to a heat sink 26 in order to reduce the temperature of the cold head below the cryogenic temperature to which the component 23 is to be cooled. The heat sink 26 expels the heat to the external environment. For example, the heat sink 26 is an air-cooled radiator, or the heat sink 26 is a heat exchanger cooled by a flow of tap water. In an alternative system, the cryocooler 24 could be replaced with another kind of apparatus providing a cold source in the cryogenic chamber. For example, the cold source could be a container of liquid nitrogen, and the liquid nitrogen would boil and nitrogen gas would be expelled to the external environment when heat would flow to the container of liquid nitrogen.

For transferring heat from the component 23 to the cold head 25, the cryogenic system 20 includes a circulation loop 27 circulating cryogenic fluid between the component 23 and the cold head 25. For example, the circulation loop 27 includes a heat exchanger 28 fastened to the cold head 25, and the cryogenic fluid flows through the heat exchanger 28 and flows from the heat exchanger to the component 23 to cool the component by picking up heat from the component. For example, the cryogenic fluid directly contacts the component 23 or contacts a heat exchanger attached to the component 23.

In the embodiment of FIG. 1, the circulation loop 27 includes a cryogenic pump 29 providing a motive force for circulating the cryogenic fluid through the loop. For example, the cryogenic pump is a cryogenic fan sold by CryoZone BV of Son, The Netherlands. However, the cryogenic pump could be omitted in a cryogenic system in which the cold head 25 is higher in elevation than the component 23 so that gravity-assisted convection would circulate the cryogenic fluid through the circulation loop 27. Gravity-assisted convection is most effective when the circulation loop 27 is configured as a thermosiphon in which cryogenic gas condenses to a liquid at the cold head 25, and the liquid flows under the force of gravity to the component 23, where the liquid boils so that cryogenic gas flows back to the cold head 25. In such a thermosiphon, the cryogenic gas flowing back to the cold head 25 may carry with it some cryogenic liquid that has not vaporized.

The present disclosure is directed to a problem of cooling elongated structure 31, 32 extending from the component 23 to a warmer environment, such as the external environment outside the housing. The elongated structure 31, 32 may serve to suspend or mount the cryogenic component in the cryogenic chamber, or may provide a way of mechanically adjusting or controlling the cryogenic component in the case of a mechanical control shaft, or may include tubes for conveying cryogenic fluid or vacuum, or may include electrical leads for conveying electrical power or electrical signals, or may include optical fiber for conveying optical signals.

In the specific example of FIG. 1, the elongated structure comprises electrical leads connecting the component 23 to an electrical current source 33 outside of the housing 21 for supplying electrical current from the current source 33 to the component 23. For example, the component 23 is a superconducting electromagnet, and the electrical current source 33 provides a variable amount of current to the superconducting electromagnet in order to adjust the strength of the magnetic field produced by the superconducting electromagnet. In another example, the component 23 is a sample of material under test, and the electrical current source 33 supplies electrical current to the sample in order to measure current-voltage characteristics of the sample as a function of temperature and the strength of a magnetic field at the location of the sample. In another example, the component 23 is an electronic circuit that is cooled to improve the performance of the electronic circuit, and the electrical current source 33 supplies electrical current to the electronic circuit in order to supply power to the electronic circuit.

The electrical current leads 31, 32 represent a significant heat leak from the room-temperature environment outside of the housing 21 and into cryogenic chamber 22. This is a consequence of the fact that presently known materials that are good conductors of electricity above a cryogenic temperature are also good conductors of heat. Moreover, conventional high-temperature superconducting (HTS) wire has a transition temperature, below which the wire becomes superconducting, of about 77 degrees Kelvin. Even if the current leads 31, 32 were entirely made of HTS wire, there would be a length of each of the current leads 31, 32 extending from outside of the housing 21 and passing through the wall of the housing 21 and extending some distance within the housing 21 until the electrical conductors would be at a temperature below the transition temperature of 77 degrees Kelvin. Consequently, when electrical current is flowing through the current leads 31, 32, heat is produced in proportion to the electrical resistance of the current leads and the square of the current. Some of this heat is produced inside the housing 21, and some of this heat is produced outside the housing 21 and is conducted through the current leads 31, 32 to flow inside the housing 21.

In order to cool the electrical current leads 31, 32 inside the housing 21, a flow 34 of the cryogenic fluid in the circulation loop 27 is directed along a length of the current leads 31, 32 extending from component 23. For example, as shown in FIG. 1, the component 23 is disposed inside a canister 30, and a portion of the current leads within the housing 21 are also disposed inside the canister 30. The cryogenic fluid from the heat exchanger 28 and the cold head 25 enters the canister 30 at an inlet port 35 near the component 23. The current leads enter or exit the canister 30 though respective gas seals 36, 37 in a cap 38 at the top of the canister 30.

The cap 38 of the canister 30 protrudes from the housing 21, and the cap 38 is removable from the canister 30 so that the assembly of the component 23 and the current leads 31, 32 is easily removable from the cryogenic system 20 without breaking a vacuum in the cryogenic chamber 22. For example, the canister 30 is made of stainless steel and is sufficiently thick to contain the cryogenic fluid at slightly above atmospheric pressure when the cryogenic chamber 22 is evacuated. The canister 30 is not thicker than needed for strength and is made of stainless steel to reduce heat conduction along its length.

It is desirable to adjust the location along the current leads 31, 32 from which the cryogenic fluid exits the canister 30 based on the amount of heat produced by the current leads or conducted through the current leads from the room-temperature environment. For example, the composition of the current leads 31, 32 may change at a location 39 so that the current leads are made of HTS wire from the location of the component 23 up to the location 39, and the current leads are made of copper from the location 39 up to the location of the electrical current source 33. In this case, the location 39 should be kept at a temperature just below the transition temperature of 77 degrees Kelvin. Therefore, it is desired for the location from which the cryogenic fluid exits the canister 30 to be located no further from the electrical or electronic component 23 than is necessary to keep the location 38 at a temperature just below the transition temperature of 77 degrees Kelvin. On the other hand, if the current leads 31, 32 were entirely made of copper, the desired location could be much closer to the location where the current leads exit the housing 21. In addition, the desired location would change if there would be a change in the amount of heat produced by the current leads 31, 32 or conducted through the current leads from the room-temperature environment. The desired location is closer to the component 23 when there is no current flowing through the current leads 31, 32, and further away from the component 23 when there is a maximum amount of current flowing through the current leads.

Because the room temperature may change or the current flowing through the current leads 31, 32 may change during operation of the cryogenic system 20, it is desired to adjust the location along the current leads 31, 32 from which the cryogenic fluid exits the canister 30 without breaking the vacuum in the cryogenic chamber 22. In this case it is impractical to translate a fluid exit port of the canister 30. However, a practical solution to this problem is to provide the canister 30 with two or more exit ports along the length of the current leads 31, 32, and to adjust at least one valve to select a respective fraction of the flow 34 that exits from each of the exit ports.

For example, as shown in FIG. 1, the canister 30 is provided with a first exit port 41 at a first location along a length of the current leads 31, 32 extending from the component 23, and a second exit port 42 at a second location further along the length of the current leads than the first location. For example, the first location is located along the length of the current leads 31, 32 between the component 23 and the second location, and the second location is located along the length of the current leads between the first location and the location where the current leads exit the housing 21. The circulation loop 27 further includes an adjustable valve 43 for adjusting a fraction of the incoming stream of the cryogenic fluid from the canister inlet port 35 that exits from the second outlet port 42. In this example, adjustment of the fraction of the incoming stream that exits from the second inlet port 42 also adjusts a corresponding fraction of the incoming stream that exits from the first inlet port 41, because the sum of the two fractions is equal to one. A first outgoing stream conduit 44 branches from the canister 30 at the first outlet port 41 for conducting a first outgoing stream of the cryogenic fluid from canister, and a second outgoing stream conduit 45 extends from the second outlet port 42 for conducting a second outgoing stream of the cryogenic fluid from the canister. The adjustable valve 43 is coupled to at least one of the first outgoing stream conduit 44 and the second outgoing stream conduit 45.

In the example of FIG. 1, the adjustable valve 43 is a three-port mixing valve that has a first port connected to the first outgoing stream conduit 44 to receive the first outgoing stream of the cryogenic fluid, a second port connected to the second outgoing conduit 45 to receive the second outgoing stream of the cryogenic fluid, and a third port coupled by a conduit 46 to expel a combined stream of the cryogenic fluid to an inlet port of the cryogenic pump 29 inside the housing 21. For example, the three-port mixing valve 43 is a spool valve having a spool 47 that is translated by a screw 48 in an axial direction when a control shaft 49 is turned. The control shaft 49 extends through a seal 50 in the housing 21 to a knob 54 for manual adjustment of the valve 43. In a lower position, the spool 47 blocks flow from the second outgoing stream conduit 45 and enables flow from the first outgoing stream conduit 44. In an upper position, the spool 47 blocks flow from the first outgoing stream conduit 44 and enables flow from the second outgoing stream conduit 45. In a middle position, the spool 47 enables flow from both the first outgoing stream conduit 44 and the second outgoing stream conduit 45.

In the example of FIG. 1, a temperature sensor 52 is disposed in the canister 30 at a location between the top of the canister and the second outlet port 42. The temperature sensor 52 is electrically connected to a temperature display 53 located outside of the housing 21. In this case the temperature sensor 52 senses a temperature that is marginally below room temperature and indicative of heat conducted through the current leads 31, 32 from outside of the housing 31 and heat generated by the conduction of current through the current leads. Therefore a need for cooling the current leads is found by comparing the temperature sensed by the temperature sensor 52 to a set-point temperature.

For example, a human operator reads the sensed temperature from the temperature display 53, and if this temperature is higher than the set-point temperature, then the operator turns the knob 54 counter-clockwise to decrease the flow through the first outlet port 41 and increase the flow through the second outlet 42, and if this temperature is lower than the set-point temperature, then the operator turns the knob 54 clockwise to increase the flow through the first outlet 41 and decrease the flow through the second outlet 42.

As shown in FIG. 2, a temperature controller 61 and a valve actuator 62 have been added to the cryogenic system for automatic control of the current lead cooling. The temperature sensor 52 is electrically coupled to the temperature controller 61 to provide a temperature signal. For example, the temperature sensor 52 is a silicon diode conducting a constant current and providing a voltage proportional to absolute temperature. The temperature controller 61 is a programmed microcontroller or a programmed general purpose digital computer having an analog input for the temperature signal, and digital inputs and digital outputs for controlling the valve actuator 62. The valve actuator 62 includes a stepper motor 63, gears 64, 65 mechanically coupling the stepper motor to the valve control shaft 49, and limit switches 66, 67 for detecting limits of travel of the valve control shaft 49.

For example, the temperature controller periodically reads the temperature sensed by the temperature sensor 52 and computes the difference between this temperature and a temperature set-point. If the difference is positive and has a magnitude greater than a noise level threshold, and the upper limit switch 66 does not indicate that an upper limit has been reached, then the temperature controller 61 pulses the stepper motor 63 to drive the control shaft 49 counter-clockwise and upward to increase the flow of cryogenic fluid through the second outlet port 42 and decrease the flow of cryogenic fluid through the first outlet port 41. If the difference is negative and has a magnitude greater than the noise level threshold, and the lower limit switch 67 does not indicate that a lower limit has been reached, then the temperature controller 61 pulses the stepper motor 63 to drive the control shaft 49 clockwise and downward to increase the flow of cryogenic fluid through the first outlet port 44 and decrease the flow of cryogenic fluid through the second outlet port 42.

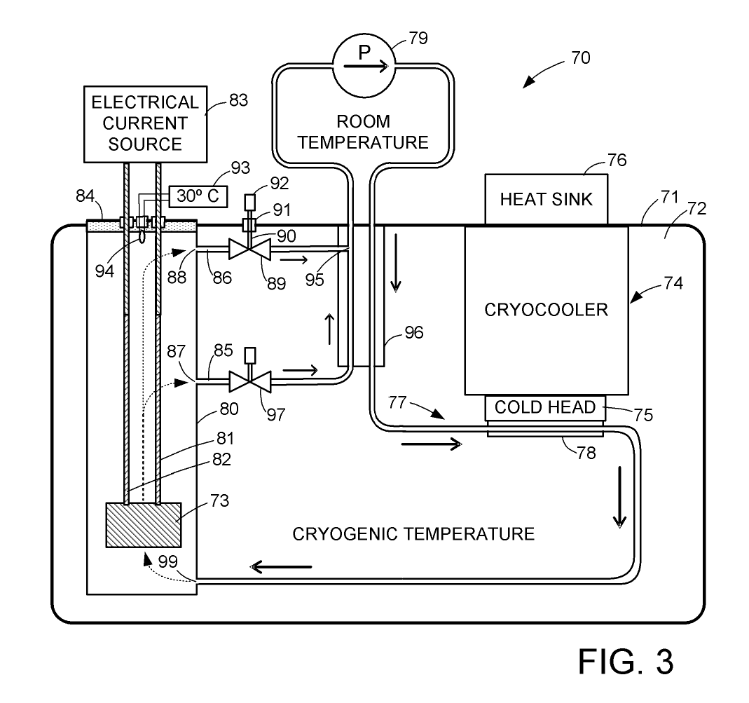

FIG. 3 shows another embodiment of a cryogenic system 70. The cryogenic system 70 includes a housing 71 providing a cryogenic chamber 72 thermally insulated from an external room-temperature environment. An electrical or electronic component 73 to be cooled to a cryogenic temperature is inserted into a canister 80. The cryogenic system 70 includes a cryocooler 74. The cryocooler 74 has a cold head 75 in the cryogenic chamber, and a heat sink 76 for expelling heat to the external environment. The cryogenic system 70 includes a circulation loop 77 circulating cryogenic gas between the electrical or electronic component 73 and the cold head 75. For example, the circulation loop 77 includes a heat exchanger 78 fastened to the cold head 75. The cryogenic gas flows through the heat exchanger 78 and flows from the heat exchanger to an inlet port 99 at the bottom of the canister 80.

In the embodiment of FIG. 3, the cryogenic circulation loop 77 includes a conventional gas pump 79 operated at room temperature outside of the housing 71. A counter-flow heat exchanger 96 is mounted inside the housing 71 and is coupled between the outlet of the gas pump 79 and the heat exchanger 78 for cooling an inflow of cryogenic gas from the gas pump 79 to the cold head 75 with an outflow of cryogenic gas from the canister 80.

The component 73 has current leads 81, 82 extending from the component 73 to an electrical current source 83 outside of the housing 71. For cooling the current leads 81, 82, the leads extend from the component 73 within the housing to a cap 84 at the top of the housing so that the canister guides a flow of the cryogenic gas along a length of the current leads extending from the component 73. To adjust the cooling of the current leads 81, 83, the circulation loop 77 further includes a first outgoing stream conduit 85 branching from the canister 80, and a second outgoing stream conduit 86 extending from the canister 80. The first outgoing stream conduit branches from the canister 80 at a first location 87 along the length of the current leads 81, 82, and the second outgoing stream conduit 86 extends from the canister 80 at a second location 88 further along the length of the current leads than the first location 87. In other words, the first location 87 is located along the length of the current leads 81, 82 between the component 73 and the second location 88, and the second location 88 is located along the length of the current leads between the first location 87 and the location where the current leads exit the housing 71. The circulation loop 77 further includes an adjustable valve 89 for adjusting a fraction of the incoming stream of the cryogenic gas from the lower port 99 that becomes the second outgoing stream of cryogenic gas through the conduit 86.

In the embodiment of FIG. 3, the adjustable valve 89 is a two-port adjustable valve in the second outgoing stream conduit 86 for adjusting a restriction in the second outgoing stream conduit. The two-port adjustable valve 89 has a control shaft 90 extending through a seal 91 in the housing 71. For manual adjustment, the control shaft 90 is terminated by a knob 92, and a temperature display 93 is electrically connected to a temperature sensor 94 disposed in the canister 80 between the top of the canister and the location 88 of the outlet port for the second outgoing stream. For automatic adjustment, the control shaft 90 would be terminated by a valve actuator operated by a temperature controller responsive to the temperature sensor 94, for example as shown in FIG. 2 and described above.

In the embodiment of FIG. 3, the second outgoing stream conduit 86 is coupled to the inlet of the gas pump 79 to direct the second outgoing stream from the canister 80 to the inlet of the gas pump. For example, the second outgoing stream conduit 86 terminates at a tap 95 on the counter-flow heat exchanger 96 in order to reduce heat flow along the length of the second outgoing stream conduit. Resistance in the counter-flow heat exchanger 96 to the flow of cryogenic gas from the first outgoing stream conduit 85 provides some pressure drop for motivating the flow of cryogenic gas through the second outgoing stream conduit 86 and through the two-port adjustable valve 89. A second two-port adjustable valve 97 has been inserted in the first outgoing stream conduit 85 to provide a way of further increasing the second outgoing stream of cryogenic gas relative to the first outgoing stream by adjustably restricting the flow of the first outgoing stream of cryogenic fluid through the first outgoing stream conduit 85. For example, both of the two-port adjustable valves 89 and 97 are needle valves.

In an alternative arrangement, a tap is not used on the heat exchanger 90, and instead the second outgoing stream conduit 86 exits the housing 71, the two-port adjustable valve 90 is located in the conduit 86 outside of the housing, and the first outgoing stream of the cryogenic gas through the first outgoing stream conduit 85 joins the second outgoing stream of the cryogenic gas at the inlet of the gas pump 79. In a majority of cases, it may be most practical to locate the adjustable valve 89 outside of the housing because this eliminates the control shaft seal 91 as well as the tap 95 on the heat exchanger 96.

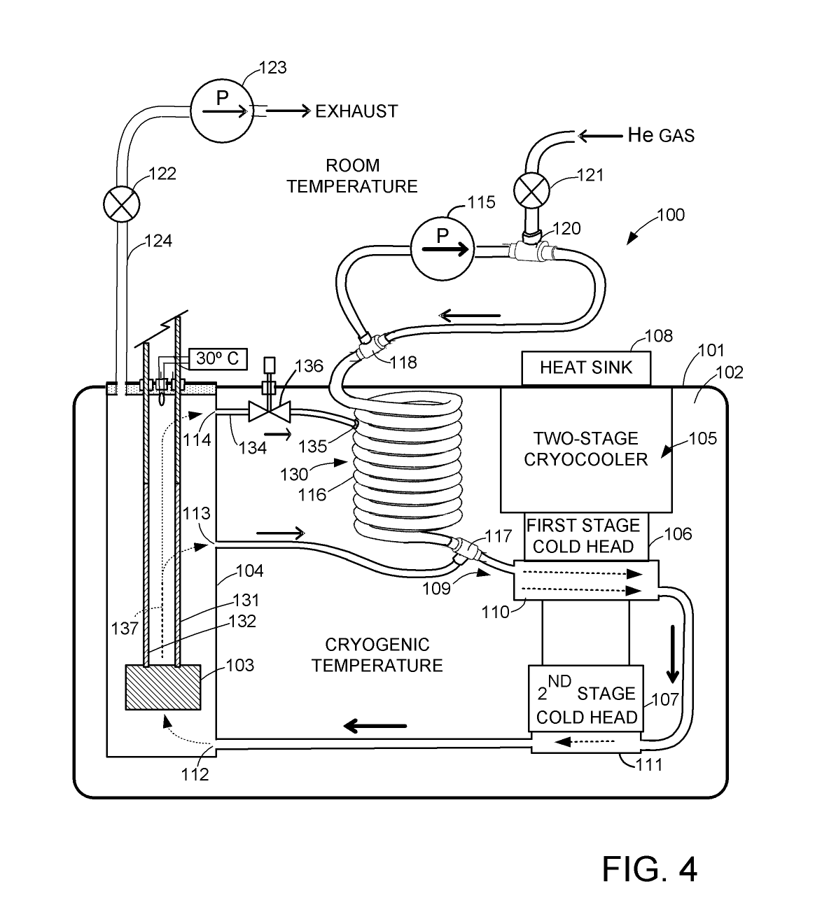

FIG. 4 shows another embodiment similar to the embodiment of FIG. 3. FIG. 4 shows a cryogenic system 100 including a housing 101 of a cryogenic vacuum chamber 102 containing an electrical or electronic component 103 in a canister 104. The system 100 includes a two-stage cryocooler 105 having a first stage cold head 106 at a cryogenic temperature, a second stage cold head 107 at a colder temperature than the first stage cold head, and a heat sink 108 to the external environment. A circulation loop 109 circulates cryogenic gas through a heat exchanger 110 fastened to the first stage cold head 106. From the heat exchanger 110, the cryogenic gas is circulated to a heat exchanger 111 fastened to the second stage cold head 107. The cryogenic gas flows through the heat exchanger 111 to the inlet port 112 of the canister 104 and into the canister, so that the cryogenic gas comes into direct contact with the component 103 to be cooled to the cryogenic temperature. The cryogenic gas then flows out a first upper port 113 of the canister 104 and into a first passage of a counter-flow heat exchanger 130 disposed between the cryogenic environment of the cryogenic chamber 102 and an external room-temperature environment. From the first passage of the counter-flow heat exchanger 130, the cryogenic gas flows into a gas pump 115 in the room-temperature environment. From the gas pump 115, the cryogenic gas flows into a second passage of the counter-flow heat exchanger 130 leading back to the heat exchanger 110 on the first stage cold head 106.

In the example of FIG. 4, the counter-flow heat exchanger 130 includes a tubular section 116 wound into a helix and having two ends terminated with respective three-port T-connector fittings 117, 118.

For charging of the circulation loop 109 with cryogenic gas such as helium, a valve 121 is opened to admit the cryogenic gas into the loop through a T-connector fitting 120. Prior to admitting the cryogenic gas, the loop 109 is evacuated by opening a valve 122 to a vacuum pump 123. A purge line 124 connects the valve 122 to the canister 104.

For adjustable cooling of current leads 131, 132 supplying electrical current to the electrical or electronic component 103, the canister 104 has a second outlet port 114 near the top of the canister. A conduit 134 connects the second outlet port 114 to a tap 135 on the counter-flow heat exchanger 130. In the counter-flow heat exchanger 130, the outflow of cryogenic gas from the first outlet port 113 is mixed with the outflow of cryogenic gas from the second outlet port 114 to provide a combined outlet flow from the housing 101. This combined outlet flow from the housing 101 is received at an inlet port of the gas pump 115. A two-port adjustable valve 136 is disposed in the conduit 134 for adjusting the fraction of the cryogenic gas flow 137 along the current leads 131, 132 that becomes the outlet flow from the second outlet port 114. For example, the two-port adjustable valve 136 is a needle valve.

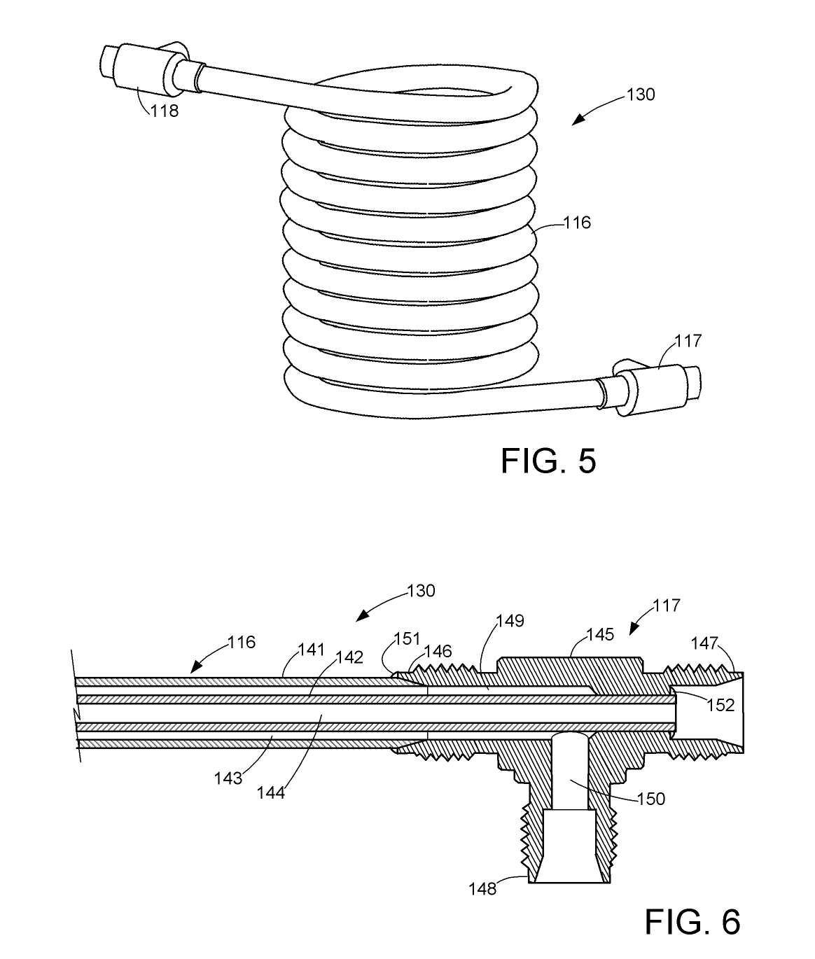

FIG. 5 shows the helical counter-flow heat exchanger 130 in greater detail. In this example, the helix of the tubular section 116 includes ten turns. There is a substantially uniform gap between neighbouring turns to reduce heat transfer between the neighbouring turns.

FIG. 6 shows that the tubular section 116 of the heat exchanger 130 includes a pair of coaxial tubes including an outer tube 141 and an inner tube 142 nested within the outer tube 141. An annular region 143 between the tubes 141, 142 provides one passage through the heat exchanger 130 (from the lower three-port T-connector fitting 117 to the upper three-port T-connector fitting 118 in FIG. 5) for the outflow of cryogenic gas from the housing of the cryogenic system to the inlet of the gas pump (115 in FIG. 4) outside of the housing, and the central region 144 of the inner tube 142 provides another passage through the heat exchanger (from the upper three-port T-connector fitting 118 to the lower three-port T connector fitting 117 in FIG. 5) for the inflow of the cryogenic gas from the outlet of the gas pump. The three-port T-connector fittings 117, 118 provide a sealed environment with independent access to each of the nested tubes 141, 142 for counter-flow through the heat exchanger, while preventing any mixing of the two counter-flows. The three-port T-connector fittings independently seal the tubes 141, 142, while allowing attachment to the rest of the components in the circulation loop.

In a preferred arrangement, the internal diameters of the two tubes 141, 142 are chosen so that the cross-sectional areas of the two passages 143, 144 are approximately equal. For example, the outer tube 141 is 5/16 inch tubing, and the inner tube 142 is 3/16 inch tubing. The overall length of the tubes is chosen to be sufficient to adequately thermally decouple the cold end from the hot end and to provide adequate heat exchange between the gas streams. For example, the overall length of the tubes 141, 142 is about six feet (183 cm). For compactness, the tubes 141, 142 are coiled into a helix having a 2.5 inch (6.4 cm) diameter, and the helix is about 3.5 inches (8.9 cm) high.

The outer tube 141 is preferably made of a low thermal conductivity material.

For example, the outer tube 141 is a type 304 or 316 stainless steel and has an outer diameter of 5/16 inches (8.0 mm) and a wall thickness of 0.035 inches (0.89 mm). The outer tube 141 provides mechanical strength through its thickness, in order to contain the cryogenic gas when the cryogenic chamber is evacuated, and maintain the shape of the helical counter-flow heat exchanger 130. The inner tube 142 should be thermally conductive and should have as thin a wall as possible while maintaining structural integrity so as to maximise heat transfer between the two passages 143, 144 and minimise heat transfer along the length of the tube. A suitable material for the inner tube 142 is copper. For example, the inner tube 142 is a standard copper tube having an outer diameter of 3/16 inches (4.8 mm) and a wall thickness of 0.028 inches (0.71 mm). Higher-purity copper, such as electrolytic tough pitch (ETP) or oxygen free high conductivity (OFHC) copper, could be used to provide higher thermal conductivity especially at lower cryogenic temperatures.

Heat transfer between the counter-flows of cryogenic gas across the thin wall of the high thermal conductivity inner tube 142 allows an equalization of temperatures in the counter-flows at any given point along the length of the inner tube 142. At the same time, the overall length of the inner tube 142 and the outer tube 141 combined with the low thermal conductivity of the outer tube 141 and the thin wall of the inner tube avoids the equalization of temperatures from the hot end to the cold end of the heat exchanger 130. The three-port connector fittings 117, 118 ensure that the counter-flows do not mix or leak into the cryogenic chamber or into the room-temperature external environment.

The minimum practical diameter of the helix is determined primarily by the minimum bend diameter of the outer tube. The minimum bend diameter of a tube is the minimum diameter of a bend that can be made by winding of the tube around a matching cylindrical grooved bender die without having the tube collapse. For example, the minimum bend diameter of a standard 5/16 inch (8.0 mm) steel or stainless steel tube is 1 and ⅞ inches (4.8 cm).

The three-port T-connector fitting includes a central body 145 and three tubular arms 146, 147, 148. Each of the tubular arms 146, 147, 148 defines a respective port. Two of the arms 146, 147 are opposite arms of a “T”, and the other arm 148 is the base of the “T”. Originally a cylindrical bore of uniform diameter passed through the body 145 between the opposite arms of a T, and this bore intersected a bore 150 from the arm 148 at right angles. The inner tube 142 has an outer diameter matching the diameters of these bores. The original bore in arm 146 is enlarged by drilling to just beyond the intersection of the “T” to provide the bore 149 in the arm 146 that receives the tubular section 116 of the heat exchanger 130. The bore 149 has a diameter equal to the inner diameter of the outer tube 141 to extend the passage 143 for flow of the cryogenic gas through bore 150 and through the port of the arm 148. The second passage 144 extends all the way to the port of the arm 147 for the flow of the cryogenic gas through the port of the arm 147.

As shown in FIG. 6, the outer tube 141 is attached externally to the arm 146, for example, by a weld, a brazing alloy seam, or a solder seam 151. The inner tube 142 is attached internally to the arm 147, for example by a weld, a brazing alloy seam, or a solder seam 152. The outer tube 141 and the inner tube 142 are attached in a similar fashion to the upper three-port T-fitting (118 in FIG. 3). The three-port T-fittings 117, 118 can be made from SWAGELOK® brand T-fittings, sold by Swagelok Company of Solon, Ohio, such as ¼ inch union tee fittings, part No. SS-400-3 or SS-4-VCR-T. In this case, for each fitting, the two ends of the fitting not attached to the outer tube 141 can be connected to the other components of the circulation loop using standard screw-on tube connectors or metal gasket fittings. These two ends of each fitting could also be welded, braised, or soldered to the other components of the circulation loop, or these two ends of each fitting could be provided with custom terminations for connection to the other components of the circulation loop.

The three-port T-fittings 117, 118 can be attached to the outer and inner tubes 141, 142 of the tubular section 116 either before or after winding of the tubular section 116 around a cylindrical grooved bender die to form the helix. Attachment of the three-port fittings 117, 118 to the tubular section 116 before winding of the tubular section 116 into a helix may result in a more concentric relationship between the outer tube 141 and the inner tube 142.

In a specific example of the cryogenic system of FIG. 4, the electrical or electronic component 103 is a sample of superconducting wire connected between copper current leads 131, 132. The housing 101 is about 25 centimeters in height, 30 centimeters in width, and 20 centimeters in depth. The components in the internal cryogenic vacuum chamber 102 are wrapped with super-insulation. The sample is about four centimetres in length. The sample and the current leads to the sample are cooled by direct contact with a flow of helium gas through the canister 104 and circulating in the circulation loop 109.

The two-stage cryocooler 105 is a model SHI CH-204 10K cryocooler sold by Sumitomo (SHI) Cryogenics of America, Inc., of Allentown, Pa. The model SHI CH-204 cryocooler should have a base temperature at the second stage cold head 107 with no load of about 9-10 K, and a cooling capacity of about 7 watts at 20 K. The first-stage heat exchanger 110 has a helical path about the first stage cold head 106 while the second-stage heat exchanger 111 has a serpentine path under the second stage cold head 107.

The gas pump 115 is a room-temperature diaphragm pump, model KNF NO22AN.18, sold by KNF Neuberger, Inc., of Trenton, N.J. The circulation loop 109 is vacuum purged and then charged with helium gas at about 0.3 bar over atmospheric pressure. The helium gas pressure differential across the gas pump 109 is about 0.1-0.2 bar (1.5-3 psi), at a flow rate of 10-15 liters per minute.

Numerous examples are provided herein to enhance understanding of the present disclosure. A specific set of examples are provided as follows.

In a first example, there is disclosed a cryogenic system including: a housing of a cryogenic chamber for containing a component to be cooled having an elongated thermally conductive structure extending from the component to a warmer environment; a cold source in the cryogenic chamber; and a circulation loop for circulating cryogenic fluid between the cold source and the component in the cryogenic chamber, wherein the circulation loop includes a flow path conduit for directing an incoming stream of the cryogenic fluid along a length of the elongated thermally conductive structure extending from the component, a first outgoing stream conduit branching from the flow path conduit at a first location along the length of the flow path conduit for conducting a first outgoing stream of the cryogenic fluid to return to the cold source, and a second outgoing stream conduit extending from the flow path conduit at a second location for conducting a second outgoing stream of the cryogenic fluid to return to the cold source, and at least one adjustable valve coupled to at least one of the first outgoing stream conduit and the second outgoing stream conduit for adjusting a fraction of the incoming stream of the cryogenic fluid that becomes the second outgoing stream of cryogenic fluid.

In a second example, there is disclosed a cryogenic system according to the preceding first example, wherein said at least one adjustable valve includes a three-port adjustable valve having a first port connected to the first outgoing stream conduit for receiving the first outgoing stream of the cryogenic fluid, a second port connected to the second outgoing stream conduit for receiving the second outgoing stream of the cryogenic fluid, and a third port for expelling a combined stream of the cryogenic fluid.

In a third example, there is disclosed a cryogenic system according to the preceding second example, wherein the circulation loop includes a cryogenic pump in the cryogenic chamber, and the cryogenic system further includes a conduit connecting the third port of the adjustable valve to an inlet of the cryogenic pump for conveying the combined stream of cryogenic fluid to the inlet of the cryogenic pump.

In a fourth example, there is disclosed a cryogenic system according to the preceding first example, wherein said at least one adjustable valve includes a two-port adjustable valve in one of the first outgoing stream conduit and the second outgoing stream conduit for providing an adjustable restriction to the flow of cryogenic fluid through said one of the first outgoing stream conduit and the second outgoing stream conduit.

In a fifth example, there is disclosed a cryogenic system according to the preceding fourth example, wherein the two-port adjustable valve is a needle valve.

In a sixth example, there is disclosed a cryogenic system according to the preceding first example, wherein said at least one adjustable valve includes a first two-port adjustable valve in the first outgoing stream conduit for providing an adjustable restriction to the flow of the first outgoing stream of the cryogenic fluid and a second two-port adjustable valve in the second outgoing stream conduit for providing an adjustable restriction to the flow of the second outgoing stream of the cryogenic fluid

In a seventh example, there is disclosed a cryogenic system according to the preceding sixth example, wherein the two-port adjustable valves are needle valves.

In an eighth example, there is disclosed a cryogenic system according to any of the preceding first, second, fourth, fifth, sixth, or seventh examples, wherein the circulation loop includes a gas pump outside of the housing, and a counter-flow heat exchanger coupled between the first outgoing stream conduit and the gas pump for directing an out-flow of the cryogenic fluid through the counter-flow heat exchanger from the first outgoing stream conduit to an inlet of the gas pump, and the counter-flow heat exchanger is also coupled between the gas pump and the cold source for directing an out-flow of the cryogenic fluid from an outlet of the gas pump to the cold source, and the second outgoing stream conduit is coupled to the inlet of the gas pump to direct the second outgoing stream of the cryogenic fluid to the inlet of the gas pump.

In a ninth example, there is disclosed a cryogenic system according to the preceding eighth example, wherein the second outgoing stream conduit terminates at a tap on the counter-flow heat exchanger.

In a tenth example, there is disclosed a cryogenic system according to any of the preceding first to ninth examples, further including a temperature sensor for sensing temperature of the elongated thermally conductive structure.

In an eleventh example, there is disclosed a cryogenic system according to the preceding tenth example, further including a valve actuator mechanically coupled to the adjustable valve for automatic adjustment of the adjustable valve, and a temperature controller electronically coupled to the temperature sensor and electronically coupled to the valve actuator for automatic control of the adjustable valve to maintain the sensed temperature at a temperature set-point.

In a twelfth example, there is disclosed a cryogenic system according to the preceding tenth or eleventh example, wherein the temperature sensor is located in the cryogenic chamber at a location along the length of the elongated thermally conductive structure between the second location and a location further along the elongated thermally conductive structure from the component.

In a thirteenth example, there is disclosed a method of cooling an elongated thermally conductive structure in a cryogenic system, the cryogenic system including a housing of a cryogenic chamber containing a component from which the elongated thermally conductive structure extends to a warmer environment, a cold source in the cryogenic chamber, and a circulation loop circulating cryogenic fluid between the cold source and the component in the cryogenic chamber, said method including: directing an incoming stream of the cryogenic fluid from the cold source along a length of the elongated thermally conductive structure extending from the component; and splitting the steam of the cryogenic fluid along the length of the elongated thermally conducive structure into a first outgoing stream of the cryogenic fluid branching away from the length of the elongated thermally conductive structure at a first location along the length of the elongated thermally conductive structure, and a second outgoing stream of the cryogenic fluid departing from the length of the elongated thermally conductive structure at a second location further along the length of the elongated thermally conductive structure than the first location; and adjusting an adjustable valve to adjust a fraction of the incoming stream of the cryogenic fluid that becomes the second outgoing stream of cryogenic fluid.

In a fourteenth example, there is disclosed a method according to the preceding thirteenth example, which further includes sensing temperature of the elongated thermally conductive structure, and adjusting the adjustable valve to maintain the sensed temperature at a temperature set-point.

In a fifteenth example, there is disclosed a method according to the preceding fourteenth example, wherein the sensed temperature is responsive to temperature of the elongated thermally conductive structure at the second location.

In a sixteenth example, there is disclosed a method according to the preceding fourteenth or fifteenth example, wherein the sensed temperature is temperature of a temperature sensor disposed along the elongated thermally conductive structure at a location between the second location and a location further along the elongated thermally conductive structure from the component.

In a seventeenth example, there is disclosed a method according to any of the preceding fourteenth to sixteenth examples, wherein the adjustable valve is disposed in the cryogenic chamber and the cryogenic system includes a control knob outside of the cryogenic chamber and a control shaft mechanically connecting the control knob to the adjustable valve, and the control knob is adjusted manually to adjust the adjustable valve.

In an eighteenth example, there is disclosed a method according to the preceding seventeenth example, wherein the cryogenic system includes a temperature sensor sensing temperature of the elongated thermally conductive structure, and a display for displaying temperature sensed by the temperature sensor, and the method includes adjusting the control knob manually in response to observing the display of the temperature sensed by the temperature sensor.

In a nineteenth example, there is disclosed a method according to any of the preceding fourteenth to sixteenth examples, wherein the cryogenic system further includes a valve actuator mechanically coupled to the adjustable valve for automatic adjustment of the adjustable valve, and a temperature controller electronically coupled to the temperature sensor and electronically coupled to the valve actuator for automatic control of the adjustable valve, and the method includes operating the temperature controller to maintain the sensed temperature at a temperature set-point.

In a twentieth example, there is disclosed a method according to any of the preceding thirteenth to nineteenth examples, wherein the elongated thermally conductive structure includes a current lead carrying electrical current between the component and the environment outside the housing, and the current lead includes a segment of superconductor extending from the component and contained within the housing, and the superconductor has a transition temperature below which the superconductor becomes superconducting, and the method includes adjusting the adjustable valve to maintain a highest temperature of the segment of superconductor just below the transition temperature.

The various embodiments described above are provided by way of illustration only and should not be construed to limit the scope of the disclosure. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims. Claim language reciting “at least one of” a set indicates that one member of the set or multiple members of the set satisfy the claim.

1. A cryogenic system comprising:
a housing of a cryogenic chamber for containing a component to be cooled having an elongated thermally conductive structure extending from the component to be cooled to a warmer environment;
a cold source in the cryogenic chamber; and
a circulation loop for circulating cryogenic fluid between the cold source and the component in the cryogenic chamber, wherein the circulation loop includes a flow path conduit for directing an incoming stream of the cryogenic fluid along a length of the elongated thermally conductive structure extending from the component, a first outgoing stream conduit branching from the flow path conduit at a first location along the length of the flow path conduit for conducting a first outgoing stream of the cryogenic fluid to return to the cold source, and a second outgoing stream conduit extending from the flow path conduit at a second location for conducting a second outgoing stream of the cryogenic fluid to return to the cold source, and at least one adjustable valve coupled to at least one of the first outgoing stream conduit and the second outgoing stream conduit for adjusting a fraction of the incoming stream of the cryogenic fluid that becomes the second outgoing stream of cryogenic fluid.

2. The cryogenic system as claimed in claim 1, wherein said at least one adjustable valve includes a three-port adjustable valve having a first port connected to the first outgoing stream conduit for receiving the first outgoing stream of the cryogenic fluid, a second port connected to the second outgoing stream conduit for receiving the second outgoing stream of the cryogenic fluid, and a third port for expelling a combined stream of the cryogenic fluid.

3. The cryogenic system as claimed in claim 2, wherein the circulation loop includes a cryogenic pump in the cryogenic chamber, and the cryogenic system further includes a conduit connecting the third port of the adjustable valve to an inlet of the cryogenic pump for conveying the combined stream of cryogenic fluid to the inlet of the cryogenic pump.

4. The cryogenic system as claimed in claim 1, wherein said at least one adjustable valve includes a two-port adjustable valve in one of the first outgoing stream conduit and the second outgoing stream conduit for providing an adjustable restriction to the flow of cryogenic fluid through said one of the first outgoing stream conduit and the second outgoing stream conduit.

5. The cryogenic system as claimed in claim 4, wherein the two-port adjustable valve is a needle valve.

6. The cryogenic system as claimed in claim 1, wherein said at least one adjustable valve includes a first two-port adjustable valve in the first outgoing stream conduit for providing an adjustable restriction to the flow of the first outgoing stream of the cryogenic fluid and a second two-port adjustable valve in the second outgoing stream conduit for providing an adjustable restriction to the flow of the second outgoing stream of the cryogenic fluid.

7. The cryogenic system as claimed in claim 6, wherein the two-port adjustable valves are needle valves.

8. The cryogenic system as claimed in claim 1, wherein the circulation loop includes a gas pump outside of the housing, and a counter-flow heat exchanger coupled between the first outgoing stream conduit and the gas pump for directing an out-flow of the cryogenic fluid through the counter-flow heat exchanger from the first outgoing stream conduit to an inlet of the gas pump, and the counter-flow heat exchanger is also coupled between the gas pump and the cold source for directing an out-flow of the cryogenic fluid from an outlet of the gas pump to the cold source, and the second outgoing stream conduit is coupled to the inlet of the gas pump to direct the second outgoing stream of the cryogenic fluid to the inlet of the gas pump.

9. The cryogenic system as claimed in claim 8, wherein the second outgoing stream conduit terminates at a tap on the counter-flow heat exchanger.

10. The cryogenic system as claimed in claim 1, further including a temperature sensor for sensing temperature of the elongated thermally conductive structure.

11. The cryogenic system as claimed in claim 10, further including a valve actuator mechanically coupled to the adjustable valve for automatic adjustment of the adjustable valve, and a temperature controller electronically coupled to the temperature sensor and electronically coupled to the valve actuator for automatic control of the adjustable valve to maintain the sensed temperature at a temperature set-point.

12. The cryogenic system as claimed in claim 10, wherein the temperature sensor is located in the cryogenic chamber at a location along the length of the elongated thermally conductive structure between the second location and a location further along the elongated thermally conductive structure from the component.

13. A method of cooling an elongated thermally conductive structure in a cryogenic system, the cryogenic system including a housing of a cryogenic chamber containing a component from which the elongated thermally conductive structure extends to a warmer environment, a cold source in the cryogenic chamber, and a circulation loop circulating cryogenic fluid between the cold source and the component in the cryogenic chamber, said method comprising:
directing an incoming stream of the cryogenic fluid from the cold source along a length of the elongated thermally conductive structure extending from the component; and
splitting the steam of the cryogenic fluid along the length of the elongated thermally conducive structure into a first outgoing stream of the cryogenic fluid branching away from the length of the elongated thermally conductive structure at a first location along the length of the elongated thermally conductive structure, and a second outgoing stream of the cryogenic fluid departing from the length of the elongated thermally conductive structure at a second location further along the length of the elongated thermally conductive structure than the first location; and
adjusting an adjustable valve to adjust a fraction of the incoming stream of the cryogenic fluid that becomes the second outgoing stream of cryogenic fluid.

14. The method as claimed in claim 13, which further includes sensing temperature of the elongated thermally conductive structure, and adjusting the adjustable valve to maintain the sensed temperature at a temperature set-point.

15. The method as claimed in claim 14, wherein the sensed temperature is responsive to temperature of the elongated thermally conductive structure at the second location.

16. The method as claimed in claim 14, wherein the sensed temperature is temperature of a temperature sensor disposed along the elongated thermally conductive structure at a location between the second location and a location further along the elongated thermally conductive structure from the component.

17. The method as claimed in claim 14, wherein the adjustable valve is disposed in the cryogenic chamber and the cryogenic system includes a control knob outside of the cryogenic chamber and a control shaft mechanically connecting the control knob to the adjustable valve, and the control knob is adjusted manually to adjust the adjustable valve.

18. The method as claimed in claim 17, wherein the cryogenic system includes a temperature sensor sensing temperature of the elongated thermally conductive structure, and a display for displaying temperature sensed by the temperature sensor, and the method includes adjusting the control knob manually in response to observing the display of the temperature sensed by the temperature sensor.

19. The method as claimed in claims 14, wherein the cryogenic system further includes a valve actuator mechanically coupled to the adjustable valve for automatic adjustment of the adjustable valve, and a temperature controller electronically coupled to the temperature sensor and electronically coupled to the valve actuator for automatic control of the adjustable valve, and the method includes operating the temperature controller to maintain the sensed temperature at a temperature set-point.

20. The method as claimed in claim 13, wherein the elongated thermally conductive structure includes a current lead carrying electrical current between the component and the environment outside the housing, and the current lead includes a segment of superconductor extending from the component and contained within the housing, and the superconductor has a transition temperature below which the superconductor becomes superconducting, and the method includes adjusting the adjustable valve to maintain a highest temperature of the segment of superconductor just below the transition temperature.
